(19) United States
(12) Patent Application Publication
(10) Pub. No.: US 2020/0009795 A1
(43) Pub. Date: Jan. 9, 2020

(54) INTERFACE LAYERS AND REMOVABLE OBJECT SUPPORTS FOR 3D PRINTING

(71) Applicant: DESKTOP METAL, INC., Burlington, MA (US)

(72) Inventors: Michael Andrew GIBSON, Boston, MA (US); Animesh Bose, Burlington, MA (US); Brian Keman, Andover, MA (US); Jonah Myerberg, Lexington, MA (US); Alexander Barbati, Melrose, MA (US)

(73) Assignee: DESKTOP METAL INC., Burlington, MA (US)

(21) Appl. No.: 16/438,087

(22) Filed: Jun. 11, 2019

Related U.S. Application Data
(60) Provisional application No. 62/683,340, filed on Jun. 11, 2018.

(51) Int. Cl. B29C 64/40; B22F 3/00; B22F 3/10; B29C 64/165; B33Y 10/00; B33Y 70/00

(52) U.S. Cl. CPC B29C 64/40; B22F 3/008; B22F 3/10; B29K 2507/04; B33Y 10/00; B33Y 70/00; B29C 64/165

(57) ABSTRACT

Materials and methods are disclosed for forming interface layers between objects being 3D printed and their underlying support structures, as well as dissolvable supports. The materials and methods facilitate separation of the objects from the supports after all processing is completed and are particularly useful when 3D printing metal objects that have to be sintered subsequent to 3D printing.

### FIELD OF THE DISCLOSURE

This disclosure describes improvements to the additive manufacturing of objects, and specifically to the field of 3D printing, including the fabrication of metal objects by a 3D printer. In particular, this disclosure is directed to novel and useful interface layers that may be incorporated when printing such objects and methods for forming removable object supports during 3D printing. Interface layers may often need to be added during the 3D printing process between one or more portions of a 3D object being printed and corresponding ancillary support structures that are included to physically support those portions during 3D printing and subsequent processing. By selecting materials for such interface layers in accordance with this disclosure, the resulting interface layers enable such support structures to be readily separated and removed from the 3D printed object upon completion of the printing and subsequent processing of the object. Further, by applying the methods disclosed herein, removable object supports may be formed.

### BACKGROUND OF THE DISCLOSURE

Over the past several decades, there has been a revolution in the technologies available for manufacturing various objects (e.g., made from plastics, metals and other materials) that has been fueled by the unique capabilities of 3D printers. Because of their versatility, 3D printers are a growing sector of the parts manufacturing market. They not only provide parts designers with the ability to rapidly prototype custom designs, but also permit factories to mass produce finalized or near finalized designs of many objects (alternately referred to herein as “parts”) at a cost competitive with and sometimes more economical than conventional manufacturing processes.

Not too long ago, 3D printers were primarily used by hobbyists to make small objects out of various thermoplastic materials. Today, 3D printers can not only make objects or parts out of a wide array of thermoplastics, but also out of various metals and other materials in ways that eliminate or significantly reduce the need for conventional machining or other finishing steps typically required to fabricate a finished part using conventional manufacturing technology.

3D printers are therefore increasingly being used to both prototype and manufacture a wide array of objects, including objects that would be more costly to manufacture by other means. Such 3D printed objects often incorporate features that would be nearly impossible to otherwise fabricate without intricate and costly conventional machining steps.

By way of example, 3D printing is already being routinely used by the aircraft industry to make highly specialized turbine engine parts; and it is widely anticipated that the market share of objects made by 3D printing will continue to grow at a fast pace.

3D printers are a form of “additive manufacturing,” as contrasted with more conventional “subtractive” manufacturing, by which an object is manufactured by removing material using standard machining techniques. In contrast, 3D printers work by adding layer upon layer of materials to build up an object in successive layers from the bottom up.

The layers may be built up in accordance with digital data provided to the 3D printer that instructs the 3D printer where to deposit material. During an exemplary 3D printing process, the data for each layer is used to provide instructions to one or more print heads that may move in an x-y plane to deposit materials (e.g., metal powders held together by an organic binder) at appropriate locations to form each cross-sectional layer. Thus, in this type of exemplary extrusion-based 3D printing system, a 3D object may be built up layer-upon-layer by print heads that, for example, extrude or otherwise deposit object-forming materials at locations provided by the data for each layer. Further details of how such extrusion-based systems may use metallic build materials to 3D print metal objects is described, for example, in U.S. Pat. No. 10,232,443, assigned to the present assignee, the entire contents of which are hereby incorporated herein by reference.

In another exemplary 3D printing system that uses “binder jetting” technology, a layer of build material (e.g., a metal powder) may first be spread onto a support, and data for each layer defines the locations where one or more print heads deposit a binder onto the powder layer that binds the powder particles together for further processing.

Such 3D printing systems and processes may be thought of as being a 3D analogue of an inkjet printer, which deposits a layer of ink at particular locations to form an alphanumeric or graphic character, under the control of a computer. Analogously, in a 3D printer, hundreds or thousands of such layers, formed from plastics, metals or other materials, are deposited on top of each other to form a 3D object.

Support structures may sometimes need to be added or incorporated into an object as it is being built up. The purpose of such support structures is to provide underlying structural support for object features such as overhangs, cantilevers, cavities or lengthy bridges or regions of material that would otherwise not be adequately supported. These support structures are analogous to scaffolding that may be used at a construction site to temporarily support portions of, for example, a bridge or archway during its construction. If such support structures are not incorporated when an object is being processed, regions of unsupported material may not have sufficient structural integrity to maintain their shape during processing and may deform under their own weight. Even if such unsupported portions of an object do not sag or deform during the initial 3D printing process, they may do so during subsequent processing.

For example, after metal objects are 3D-printed, subsequent processing may include chemical and/or high temperature processing to remove any binders that were incorporated during the printing process and to densify the 3D printed object. For example, chemical and/or thermal debinding steps may be needed to remove polymer binders from metal objects after they are printed; and high temperature sintering is generally needed to densify 3D-printed metal objects to their near bulk metal densities.

Structural supports therefore need to be strong enough to physically support corresponding portions of a 3D printed object as it undergoes these debinding and sintering steps. Structural supports also should have properties that are similar to and compatible with the build material of the object so that, for example, the object and its support structures will not differentially expand or shrink during sintering in ways that may stress or deform the object.

Since these ancillary support structures do not form part of the final 3D printed object, just like support scaffolding at a conventional construction site, they ultimately need to be separated and removed from the object, e.g., after the sintering step. Such support removal has typically been difficult, costly and time consuming in the prior art. It is therefore highly desirable to develop new techniques and materials that permit such support structures to be easily separated and removed from an object, particularly a 3D printed metal object, preferably by hand manipulation, and without having to resort to using tools or additional machining steps to separate and remove the support structures.

To achieve this goal, workers have used ceramic particles to form ceramic interface layers between the support structures and the 3D printed metal objects. Since the ceramic particles do not react or bond appreciably to metal objects at typical metal sintering temperatures, they are useful for forming interface layers that permit the support structures to be easily separated from the metal objects after sintering.

As evident from the prior art use of ceramic particles to form interface layers, it should be understood that the “layer,” as used herein, is not limited to a homogeneous, planar layer, but refers to a structure or region that generally has a two-dimensional extent. A layer may not be completely planar, but may have a tortuous geometry in three-dimensional space while maintaining a substantially two-dimensional character in many locations locally. In some instances, a layer may be discontinuous or may exhibit a perforated structure. The thickness of a particular layer may be either relatively constant or may vary at different locations within the layer, and in some locations, the thickness of the layer may be zero.

It should be further understood that the deviations of a layer from absolute planarity and constant thickness may occur due to process non-idealities (e.g. a lack of planarity of a spreading device with respect to a prior flat layer of powder, notches or abrasions in the spreading devices, and/or unintended or otherwise incidental machine vibrations). Alternatively or additionally, such deviations in a layer may occur as intentional aspects of the fabrication process (e.g. use of a non-constant layer height to increase build rate in certain regions, use of a tilted spreading device to facilitate powder flow, etc.). It should further be understood that the characteristics of a layer, such as the thickness and/or geometry of a layer, may vary from one layer to a next, as well as within a layer. Moreover, a layer may comprise a mixture of several materials that may have microscopic and/or macroscopic size scales.

For example, U.S. Pat. Nos. 9,815,118 and 9,833,839, whose entire disclosures are incorporated herein by reference, and which are assigned to the same assignee as this application, provide details of how ceramic powder interface layers may be interposed between support structures and 3D printed metal objects having complex geometries, to permit the support structures to be more easily removed after processing is completed, either by hand manipulation or by slightly tapping on the object. As described in the aforementioned patents, this is made possible because the ceramic powders that form the interface layer are only weakly bonded to the metal surfaces of an object and their underlying support structures.

To illustrate a typical 3D printing process, FIG. 1 shows a 3D printer system that uses binder jetting technology to 3D print metal parts. As mentioned above, in binder jetting a layer of metal particles is deposited, and a binder is then selectively ink-jetted at specified locations onto the metal particle layer to build a layer of the metal object. After printing all layers, the 3D object may be debinded and sintered to form a final densified metal object.

By way of example, FIG. 1 shows a support structure 420 formed to support the upper portion of a dome-shaped object 416. FIG. 1 also shows a relatively thin interface layer 422 interposed between the support structure 420 and the object 416. In an exemplary embodiment, the interface layer 422 does not bond to the support structure 420 or to the object 416 during sintering. This permits the support structure 420 to be easily removed thereafter from the object 416.

By way of further background and example, FIG. 1 shows additional aspects of a 3D printer that uses binder jetting technology. As shown in FIG. 1, a 3D printer 400 for binder jetting may include a powder bed 402, a spreader 404 (e.g., a roller) movable across the powder bed 402, a print head 406 movable across the powder bed 402, and a controller 408 in electrical communication with the print head 406. The powder bed 402 can include, for example, a packed quantity of a first metal powder 410. The spreader 404 may be moved across the powder bed 402 to spread a layer of powder 410 from a supply 412 of a powdered material across the powder bed 402. In one aspect, the spreader 404 may be a bi-directional spreader configured to spread powder from the powder supply 412 in one direction, and from a second supply (not shown) on an opposing side of the powder bed 402 in a return direction in order to speed the processing time for individual layers.

As further shown in FIG. 1, and explained in the aforementioned U.S. Patents, the print head 406 may include a discharge orifice and may be controlled to dispense a binder 414 through the discharge orifice onto the layer of powder spread across the powder bed 402. In an exemplary embodiment, the binder 414 may include a carrier and particles of a second metal dispersed in the carrier and, when dispersed onto the powder layer, can fill a substantial portion of void space of the powder 410 in the layer such that the particles of the binder 414 are dispersed among the particles of powder 410 in the layer.

In an exemplary embodiment, the particles of the binder 414 may have a lower sinter temperature than the particles of the powder 410, and the distribution of particles throughout the particles in the powder bed 402 can facilitate formation of sinter necks in situ in the three-dimensional object 416.

The supply 412 of the powdered material may provide any material suitable for use as a build material as contemplated herein, such as a sinterable powder of material selected for a final part to be formed from the object 416. The supply 412 and the spreader 404 may supply the powdered material to the powder bed 402, e.g., by lifting the powder 410 and displacing the powder to the powder bed 402 using the spreader 404, which may also spread the powdered material across the powder bed 402 in a substantially uniform layer for subsequent binding with the binder 414 provided by the print head 406.

In operation, the controller 408 may control the print head 406 to deliver the binder 414 from the print head 406 to each layer of the powder 410 in a controlled two-dimensional pattern as the print head 406 moves across the powder bed 402. Movement and actuation of the print head 406 to deliver the binder 414 can be done in coordination with movement of the spreader 404 across the print bed. For example, the spreader 404 can spread a layer of the powder 410 across the print bed, and the print head 406 can deliver the binder 414 in a controlled two-dimensional pattern to the layer of the powder 410 spread across the print bed to form a layer of a three-dimensional object 416.

As further described in the afore-mentioned U.S. Patents, these steps can be repeated in sequence (e.g., by using the appropriate two-dimensional pattern for each respective layer) to form subsequent layers until, ultimately, the three-dimensional object 416 is formed in the powder bed 402.

The printer 400 may more specifically be configured to apply the binder 414 according to a two-dimensional cross section of the computerized model and to apply a second binder (which may be the same as the binder 414 for the object) in a second pattern to bind other regions of the powdered material to form a support structure 420 adjacent to one or more surfaces of the object 416 that may need to be supported. This may, for example, be based on a second computerized model of a sinter support for the object, e.g., designed to support various features of the object 416 against collapse or other deformation that may occur during printing, debinding or sintering. For example, as shown in FIG. 1, a support structure 420 is fabricated under the three-dimensional object 416 to provide support against drooping or other deformation of object 416 during subsequent processing and sintering.

In these instances, a deposition tool 460 may be configured to apply an interface material at an interface between the support structure 420 and the object 416 to form an interface layer 422 that resists bonding of the support structure 420 to the object 416 during sintering at sintering temperatures suitable for the powder 410.

For example, as described in the aforementioned U.S. Patents, the deposition tool 460 may deposit a colloidal suspension of ceramic particles sized to infiltrate the sinterable powder in a surface of the support structure 420 adjacent to the object 416. The ceramic particles may, for example, have a mean particle size of one micron or less, or at least one order of magnitude smaller than a similarly measured mean particle size of the sinterable metal powder. These smaller particles may infiltrate the powder 410 in the interface layer 422 and form a barrier to formation of necks between the particles of the powder 410 during the sintering process.

In another example, the interface material may include a layer of ceramic particles deposited at a surface of the support structure 420 adjacent to the object 416. These ceramic particles may be solidified, e.g., in a binder or the like to prevent displacement by subsequent layers of the sinterable powder, thus forming a sinter-resistant ceramic layer between the support structure 420 and the object 416. The ceramic particles may, for example, be deposited in a carrier that gels upon contact with the sinterable powder in the powder bed 402, or in a curable carrier, where a curing system such as a light source or heat source is configured to cure the curable carrier substantially concurrently with deposition on the sinterable powder, e.g., to prevent undesired infiltration of the ceramic particles into any adjacent regions of the support structure 420 or the object 416

In another aspect, the interface material may include a material that remains as an interface layer physically separating the support structure from the object after debind and into a thermal sintering cycle, e.g., where a ceramic powder layer is deposited and cured into position before another layer of powder 410 is spread over the powder bed 402.

In one aspect, the interface material may be deposited in an intermittent pattern such as an array of non-touching hexagons between the support structure 420 and the object 416 to create a corresponding pattern of gaps between the support structure and the object after sintering. This latter structure may usefully weaken a mechanical coupling between the support structure 420 and the object 416 to facilitate removal of the support structure 420 after sintering.

Other suitable techniques for forming a sinter-resistant layer on a sinterable three-dimensional object are described by way of non-limiting examples, in Khoshnevis, et al., “Metallic part fabrication using selective inhibition sintering (SIS),” Rapid Prototyping Journal, Vol. 18:2, pp. 144-153 (2012) and U.S. Pat. No. 7,291,242 to Khoshnevis, each of which is hereby incorporated by reference in its entirety.

### BRIEF SUMMARY OF THE DISCLOSURE

Against this background, new and useful materials and techniques are disclosed herein for fabricating interface layers between underlying support structures and corresponding supported portions of a 3D printed metal object, that can be easily removed from the 3D-printed metal object after it is sintered.

### BRIEF DESCRIPTION OF THE DRAWINGS

FIG. 1 illustrates an exemplary 3D printing system that uses binder jetting, in which an interface layer is used to separate a dome-shaped object from an underlying support structure.

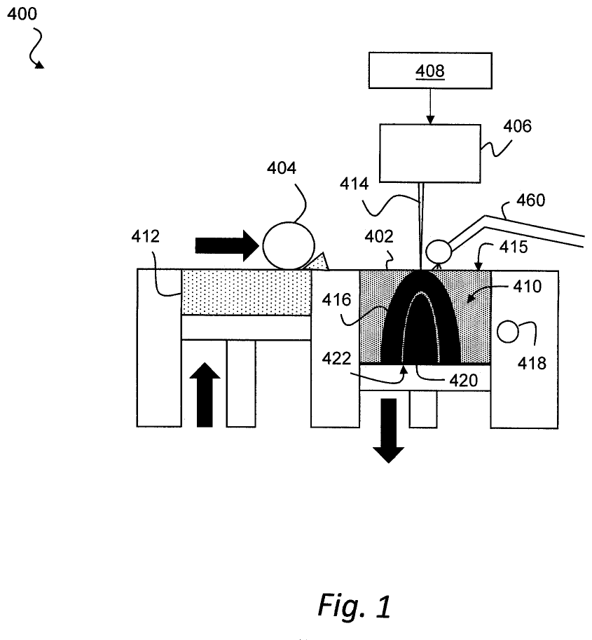

### DETAILED DESCRIPTION

As discussed above, in the prior art interface layers designed for easy removal have been formed from ceramic powders that are resistant to sintering at the temperatures required to sinter 3D-printed metal objects. The ceramic powders form an inert sinter-resistant interface layer between support structures and the object, so that the support structures can be easily separated from the object after sintering is completed.

However, the use of ceramic powder-based interface layers is not always optimum or desirable. For example, in some instances, the use of ceramic materials as interface layers may be incompatible with the materials being sintered from a chemical perspective. In other instances, non-ceramic materials, for example as described below, may be more easily interposed between the support structures and a part due to the chemical and physical properties of these materials.

An example of how material characteristics may influence the ease of delivery of an interface-forming material to the part is illustrated by using silica-based glass powders that may be suspended in inkjet fluids to form interface layers. Advantageously, silica-based glasses have very low densities compared to other oxides previously used in the art as interface layers (e.g. crystalline aluminum oxides), and therefore may form more stable suspensions in an inkjet fluid than other, denser oxides such as ceramic oxides that have been used in the prior art.

In other cases, differences in shrinkage rates between prior interface layer formulations and the part and support structures may cause decreased tolerances or increased rates of cracking in the 3D printed object. In such circumstances, a soluble interface layer may be preferred instead of a non-bonding interface layer based on ceramic powders. Accordingly, there is a need for interface layers made from materials other than ceramic powders that will permit support structures to be easily separated and removed from a 3D-printed metal object, after all processing steps including sintering have been completed.

In another aspect, an exposed material surface may be sensitized by introducing an agent that changes the local corrosion characteristics of the material, making it possible to selectively dissolve away the local volume whose corrosion characteristics have changed so as to separate an 3D printed object from an underlying support structure, or in some cases, dissolve the support structure entirely.

The use of carbon additions to stainless steels has been explored by Hildreth et al. (see, e.g. “Dissolvable Supports in Powder Bed Fusion-Printed Stainless Steel,” 3D Printing And Additive Manufacturing, Vol. 4, No. 1, 2017). In this work, carbon was introduced to a 3D printed part by a carburizing treatment after the 3D printing process. The carbon was introduced to the surface of the part by solid state diffusion, allowing only the near-surface areas of the part to be dissolved away, while leaving the interior portion of the part (wherein the chemistry was not affected) substantially unaltered and corrosion resistant.

While this method may be useful for selective laser melting applications, the method has its limitations, and is not applicable to 3D metal printing that requires a post printing sintering process for several reasons. First the dissolution step intrinsically removes material everywhere on the surface of the part, which means that the resolution of the printing process is reduced and a fillet is introduced everywhere on the part. This is undesirable from the perspective of making well-toleranced geometries.

Second, in order to remove support structures, one must dissolve the entirety of the support structure, and so the amount of material dissolved is proportional to the thickness of the support structure used. Because the support structures do not need to be thick in laser melted parts (e.g. several hundred microns in their thinnest dimension in some cases), one does not need to remove a lot of material from the part overall. However, in the case of binder jetted parts, support structures often need to be substantially thicker such that the parts are properly supported during sintering (e.g. greater than 1000 microns in their thinnest dimension in many cases), and to ensure that the support structures do not fracture during handling and depowdering.

Additionally, this prior art method introduces another thermal processing step that is costly and expensive. Lastly, this method is disadvantageous because it introduces a lack of certainty about the chemical composition of the surface near the local volume whose corrosion characteristics have been changed, and may intrinsically reduce the corrosion resistance of the surface by raising its carbon level above what it otherwise would be.

The control of process parameters to facilitate dissolution of support structures has been disclosed by Hildreth et al. (e.g. in “PROCESS CONTROLLED DISSOLVABLE SUPPORTS IN 3D PRINTING OF METAL OR CERAMIC COMPONENTS,” U.S. Patent Publication 2019/0039137A1). This Publication discusses how changes in thermal processing parameters during what apparently is a laser-based 3D printing process, can result in local changes to the corrosion characteristics of a part by altering its microstructure. In particular, these changes are described as being produced by varying the laser power and corresponding material temperatures during 3D printing.

Such thermal parameters are not available to selectively alter metal parts made by binder jetting or extrusion-based 3D printers, since the microstructure of the metal is not altered during the 3D printing process, but rather during sintering after the 3D printing process is completed, where all of the densification and microstructural evolution takes place. Methods that rely on locally changing thermal processing during printing, as disclosed in this prior art, are therefore not applicable to metal parts made by 3D printers that use binder jetting or extrusion-based technologies.

Local alteration of the chemistry of a printed part for the purpose of changing its dissolution characteristics has also been described in the prior art for parts fabricated by directed energy deposition (see, e.g. “Impact of compositional gradients on selectivity of dissolvable support structures for directed energy deposited metals,” Acta Materialia Volume 153, July 2018, Pages 1-7). In this work, powders were mixed together within a layer in an attempt to create a material with a compositional gradient, and efforts are described for utilizing the compositional gradient to achieve a gradient in corrosion behavior. Although this prior art showed that one can mix various feed powders together in a directed energy deposition additive manufacturing process to achieve different compositions, the results were not clearly detailed in that the corrosion differences were introduced for very coarse layer heights and track widths (130×790 microns, respectively)

Further, the compositional gradients were not well-controlled between layers or within layers, since each layer exhibiting substantial inhomogeneity within the layer, and layer-to-layer re-melting caused substantially chemical mixing between the layers. These limitations are likely inherent to the directed energy deposition process used in this prior art, which is inherently low-resolution and coarse in terms of compositional control, because the compositional control is achieved by mixing powders together. Such a highly inhomogeneous chemical compositional gradient is likely to lead to a very inhomogeneous gradient in dissolution behavior, and therefore likely to yield rough, incomplete dissolution at the interface since properties near the interface are not well-defined due to the mixing between layers.

Thus, although these efforts in the prior art have contemplated the concept of soluble supports for metals, the prior art has yet to disclose methods for producing parts with soluble support structures that can provide high resolution, high printing throughput, and that are compatible with existing machine architectures, build rates and mechanisms.

In spite of these prior art efforts, they have not taught how to achieve soluble supports for 3D printed metals in practical ways that are likely to be adopted by industrial practitioners of metal additive manufacturing. At heart, this is largely due to the intrinsic difficulties of introducing patterned gradients in the chemical and corrosion properties of 3D printed metal parts with appropriate precision and length scales.

In accordance with one aspect of this disclosure, we describe implementations of such compositional gradients that are compatible with binder jetting and material extrusion 3D printing processes that provide soluble metal support structures in additively manufactured parts. To do so, we describe novel machine architectures for these additive manufacturing processes, as well as novel printed geometries aimed at solving difficulties associated with post-processing the parts through debinding and sintering.

In order to create compositional gradients in binder jetted parts, one must re-conceive of the binder jetting processes used for metals, and how to introduce compositional gradients during printing relative to what was discussed in the prior art.

Specifically, when operating a binder jet 3D printer, it is strongly preferred to only use one powder blend during the printing process. This provides a uniform powder bed and powder bed density, uniform packing, and uniform imbibition of the binder into the powder. Prior art attempts at creating compositional gradients in metal additive manufacturing for forming soluble supports have only sought to create compositional differences by varying the composition of the input powder.

In contrast to such prior art attempts, this disclosure takes advantage of the inkjet printheads intrinsic to binder jet printing to add a compositional degree of freedom to the binder jet's binder deposition. In doing so, this approach allows the patterning of composition at a much finer length scale and in a more precise manner than achievable by the prior art.

In traditional metal binder jetting processes, only one printhead is used. Significantly, in one aspect of this disclosure a second print head may be provided in a binder jet 3D printing system, and may be used to selectively provide an agent for locally modifying the chemical composition of the support structures. This second print head is able to provide micro-patterned chemical compositions to achieve soluble metal supports for additive manufacturing with resolution, compositional control, and build rate superior to prior efforts to achieve soluble supports for metal additive manufacturing.

In one aspect of this disclosure, an agent, e.g. carbon, that changes the local corrosion characteristics may be introduced locally in select regions of a part during a 3D printing process that uses binder jetting or material extrusion. In an embodiment, the agent may be introduced by ink-jetting an ink containing the agent using the aforementioned second print head, into select regions during a binder jet fabrication process. Alternatively, this can also be achieved by using a multi-material extrusion 3D printing system to print parts, where one of the extruded materials contains the agent to be locally introduced.

In a binder jetting system, a sensitizing agent may be jetted onto a metal powder by using a supplemental pass or, in a preferred embodiment, by providing an additional print head, e.g., by incorporating deposition steps that add a material in a selected region or regions that will penetrate the exposed surface, and preferably will not diffuse away, evaporate away, or otherwise leave the selected region(s) during a subsequent thermal processing cycle.

As one example, this may include jetting down a carbon-containing agent in the form of carbon black or a polymer which imparts a carbon-containing residue. As another example, one may jet down a sulfur-containing agent, e.g., in the form of sulfates, a polymer that imparts a sulfur-containing residue, or other sulfur-containing compounds.

The change in the local corrosion characteristics introduced in the select region(s) may be utilized to thereafter dissolve away portion(s) of the structure after a sintering or infiltration process. In many cases, it will be useful to dissolve support structures and/or interface layers from a three-dimensional part.

In a case where an agent is introduced that enhances the corrosion rate of a select region relative to the corrosion rate of regions where the agent is not introduced, the agent may be introduced to the support structures to permit their dissolution without dissolving the part.

In a case where an agent is introduced that decreases the corrosion rate of the select region relative to the corrosion rate of regions where the agent is not introduced, the agent may be introduced to the three dimensional part such that the support structures may be dissolved with less effects of dissolution occurring on the three-dimensional part.

Typical dissolution steps for metal parts may occur in solutions with engineered pH and salt levels to enhance differences in corrosion rates between two materials (one that has been modified the agent and the other that has not been modified), or in order to enhance absolute corrosion rates such that the dissolution rate occurs more quickly. A voltage may also be applied between the part and a counter electrode to further enhance differences in corrosion rates. Although the effects of an additive (e.g. carbon) on the corrosion behavior of a selected region relative to a region without the additive will be dependent on many factors (e.g. alloy system, additive choice, additive level, solution chemistry), techniques may be used to identify promising conditions for good dissolution conditions. For example, one may print a specimen containing the additive at the desired level, another without the additive, and collect DC polarization curves for both of the specimens. The ratio of corrosion currents at a given voltage yields the relative corrosion rates of the two materials. Particularly good operating conditions will be ones where the corrosion rates differ by a factor of three or more between the material with the additive and the material without the additive.

Carbon introduction can have a strong effect on the corrosion behavior of some alloy systems, specifically stainless steels. Localized carbon deposition may thus usefully yield a soluble interface layer, especially when introduced into a stainless steel. This may be particularly useful in fabrication processes where the ability to change a base material is limited, e.g., powder bed fabrication techniques such as binder jetting wherein one cannot easily change the feed powder without causing potential defects in the part and contaminating powder such that it cannot be reused.

In this context, a carbon powder may be introduced to the exposed surface of the powder bed in regions where a separation interface is desired. Local carbon deposition may also be achieved during an inkjet printing process by, for example, jetting a carbon-laden ink into the powder bed in those regions where carbon is desired to be deposited.

Local carbon deposition may also be achieved during an inkjet printing process by, e.g., jetting a fluid containing a polymer that pyrolizes to leave behind a carbon-containing deposit. Many such polymers are known in the art that are soluble in typical ink-jetting solvents, including poly(acrylic acid) and methyl cellulose.

Additionally, local carbon deposition may be achieved by performing a case carburizing treatment as part of a sintering operation or a post-processing step. This may also or instead include heating the target surfaces in a carbon-rich atmosphere, e.g., where carbon is carried in a gas phase or the like.

Other related techniques may be used to change the local corrosion behavior of the part to enhance the dissolution rate of the support structures and/or interface layer. For example, non-stainless steel may be changed into a stainless-steel part by depositing suitable corrosion-controlling additives such as chromium or nickel that make the steel non-corrosive.

For a stainless steel, enhanced corrosion resistance may be achieved by jetting a chromium, nickel, or molybdenum-containing ink (e.g. including nanoparticles containing these elements, or as dissolved species in a fluid such as ammonium heptamolybdate) onto the portions which are intended to be corrosion-resistant, and jetting an ink which lacks these species onto those areas which are intended to be less corrosion-resistant. More generally, any similar technique for exposing an object to an agent that changes the corrosion behavior of the base material, or otherwise diffusing an agent that changes the corrosion behavior of the base material into a target surface may also or instead be used.

Similar results may be achieved with multi-material printing. For example, a part may be fabricated using a build material containing powdered, sinterable stainless steel, and a dissolvable interface layer may be fabricated using a stainless steel that has been enriched in, e.g., sulfur, carbon, boron, silicon, phosphorus and so forth so that the sintered interface layer can be dissolved in an acid bath or the like.

While an entire support structure may also or instead be fabricated from a dissolvable metal, this may introduce shrinkage matching issues due to the difference in chemistry between the support structure and the part. Thus, in another aspect of this disclosure, supports and the object may be fabricated from materials that have similar shrinkage rates through debinding and/or sintering, and the interface layer may be formed from a material that sinters into a sensitized material, e.g., an enriched stainless steel that can be removed through dissolution without dissolving the build material (and optionally without dissolving the support material). Building solely the interface layer out of a shrinkage-mismatched material with differing chemistry from the part and support structures may reduce the overall geometric incompatibility between the support structures and the parts during the shrinkage process, and therefore enable a higher-yield and a more geometrically accurate sintering process.

In a related aspect, corrosion-enhancing elements may be introduced as layers or regions throughout the support structure so that the support structure may be locally corroded away after sintering. This approach allows the support structure to maintain a large portion of its original physical, chemical, and shrinkage characteristics on average, while at the same time allowing the support structure to be partially disconnected/disassembled, and therefore more easily removed from the part.

In one example, a support structure may contain a tessellated pattern for the introduction of a corrosion-enhancing element such that the support structures may be removed after the dissolution step in a facile manner from underneath the part. In this manner, a support structure which is solid during sintering may be removed like Jenga™ blocks from underneath the part after the dissolution treatment.

Other techniques may also or instead be used to sensitize a surface to make it susceptible to corrosion or dissolvable, e.g., in an acid bath or the like. For example, galvanic corrosion may be induced by creating an electrical circuit through an object in a suitable solution and applying current to sensitize exposed surfaces. More generally, a variety of techniques may be used to apply sensitizing treatments such as those described above.

More generally, a variety of chemical pathways for sensitizing materials are known in the art, and may generally use a sensitizing agent delivered in a liquid phase, a gas phase, or as a solid. By way of example, a liquid phase coating may include a zincate coating that causes zinc to precipitate out onto part. In another aspect, electroless nickel plating or chromate conversion coatings may be used, although masking may be required to prevent sensitization of object surfaces.

For gas sensitizing, suitable paths to corresponding surfaces in the interior, or within support regions, should remain open during exposure. For gas phase sensitization, techniques such a chemical vapor deposition or physical vapor deposition may be used to maintain surface exposure to gas phase sensitizing agents. For solid phase sensitization, particle jetting, painting or dip coating of solid state particles may be used to apply sensitizing agents. Where the exposure process is not steered/steerable, e.g., where the sensitization occurs in a gas or liquid, the corresponding surfaces may be masked to limit sensitization to desired target areas.

The resulting object may then be placed in a solvent to which sensitized and unsensitized surfaces have different corrosion resistance. Alternatively, all exposed surfaces may be sensitized, but an interface between the object and the support may be fabricated to couple across minimal (e.g., proportionally small surface area) cross-sections that are engineered to dissolve/detach substantially more quickly that adjacent object surfaces in a suitable solvent.

In another aspect, mechanical embrittlement may usefully be employed to compromise the structure of a sinterable object along an interface layer. This may include plate-like filler that does not sinter, and promotes crack propagation in desired directions. More generally, any form of mechanical embrittlement may also or instead be employed. In one aspect, a material or additive may be introduced to encourage expansion, or to encourage a change in the coefficient of thermal expansion around the region of an interface layer to promote formation of mechanical defects that allow a support structure to be readily removed from the 3D printed object.

As discussed above, in accordance with one aspect of this disclosure, interface layers may be constructed from materials that form into amorphous glass-like structures during thermal processing, such as silica or other glassy materials. When used as interface layers, such glassy materials are generally brittle and may be readily fractured to permit easy separation of support structures from a 3D printed metal object, after the sintering process has been completed.

For example, materials that form amorphous glass-like structures may be selected to have glass transition or softening temperatures below the sintering temperatures reached during processing of a particular metal. During sintering, such glassy materials will melt before the maximum sintering temperature is reached without significantly infiltrating the metal build material, so as to leave a brittle glass interface layer in place upon cool down that permits easy separation of the sintered metal object from its support structures when processing has been completed.

Examples of such glassy materials suitable for use during sintering of metal objects, includes SiO₂, which has a glass transition temperature in the range of 400° C. to over 1700° C. depending on the incorporated dopants. For example, pure silica glass has a softening temperature of roughly 1700° C., whereas soda lime glass has a softening temperature around 600° C. Thus, if the metal object is being fabricated from steel and requires a sintering temperature of around 1300° C., glassy materials for the interface layer may be chosen from the silicate glass family, with pure silica glass being one example. Such a glass which will begin to flow when the sintering oven reaches a temperature of around 1000° C., and form into a glass upon cool-down below 1000° C. if the cooling rate is sufficiently high.

An advantage of using such glassy materials, is that they will not significantly infiltrate the support or build materials because of their high viscosities and the timescales of most sintering processes. Rather, such glasses will form a brittle glassy interface layer that can be readily fractured for easy separation and removal of the underlying support(s).

The most common candidate glasses for such materials include soda-lime glass (Si—Ca—Na—O based), borosilicate glass (Si—B—Al—Na—O based) , and lead-alkali glass (Si—Pb—Na—K—O based), and fiber glass (Si—Al—Ca—O based). The most common glasses will have between 50-80 wt. % silica, with various other additions as-needed. For use as an interface layer material, the amount of refractory additions (such as Al) may be used to control the reactivity of the glass, and the amount of other additions may be used to control its rheological properties.

Cermets are composites of metals and ceramics in which the ratio of metal to ceramic may be varied over a wide range. In another embodiment, the interface layer may be formed from a cermet that exhibits reduced bonding characteristics with the printed metal material.

For example, when the printed material is steel, a cermet formed from a combination of steel and ceramic (e.g., aluminum oxide) can be used as the material for the interface layer since the combination of steel and aluminum oxide ceramic will exhibit reduced bonding characteristics with the native steel during sintering.

Advantages that may be achieved by using cermets as the interface layer material include the ability to flexibly engineer the bonding characteristics of the interface layer and the shrinkage mismatch between parts through the selection of the chemistry of the two or more materials used to form the cermet, the particle sizes of the materials forming the cermet, and the volume fractions of the metal relative to the ceramic components of the cermet.

During sintering, the metallic portion of the cermet may weakly react along the boundary regions between the interface layer and the object and/or support. However, the ceramic particles will remain inert, causing the bond between the interface layer and object/support structures to be relatively weak and easily broken so as to allow for the object to be easily released from the support structures.

Another advantage of using cermets instead of simply ceramic powders for the interface material is that the use of cermets allows for some amount of bonding and shrinkage to be introduced across the interface layer, which may reduce instances of cracking of the parts due to a mismatch in shrinkage between the parts and support structures.

Since cermets can be made in a wide range of compositions using different metals and ceramics, they can be tailored to have similar thermal expansion characteristics to the build material to avoid undesirable stresses in the build material during thermal cycling. Yet, when used as an interface layer, they can provide a weak bond to the build material that facilitates the easy separation of the build material from any support structures due to the brittle nature of cermet materials.

As one example, when the printed material is steel, then a cermet composed of steel and aluminum oxide can be used as the interface layer since aluminum oxide and steel will not react.

As another example, when the printed material is titanium, a cermet composed of titanium and zirconium oxide may be used.

As yet another example, when the printed material is titanium, a cermet composed of titanium aluminide and zirconium dioxide may be used.

In yet another embodiment, the interface layer may be formed of a ceramic macrostructure. For example, the interface layer may be deposited as a paper or a fabric weave, or in some other form factor that maintains a cohesive structure. This layer will not reduce to a powder or dust, but will instead sinter into a structure that retains a mechanical macrostructure that resists bonding to adjacent layers of an object and/or support. Such a layer may, for example, be formed as a coating with a paper or foil backing or the like, and may be applied by hand or with a machine such as a web feeder, particularly for large, uniform planar surfaces such as single or multi-layer raft structures.

Ceramic paper (also called ceramic fiber paper) is one such feedstock that may be used to create such ceramic macrostructures. Such ceramic paper may be formed having high ceramic content suitable for resisting bonding to the object and its support structures. Suitable chemistries include alumina, silica, and aluminosilicate for the fiber materials. Ceramic paper is available from Ceramaterials (Port Jervis, N.Y.) and Morgan Thermal Ceramics, although other vendors may also provide suitable ceramic papers.

In another aspect, the interface layer may be formed using a polymer derived ceramic, or any other material that reduces into a ceramic during a thermal process such as sintering.

The polymer derived ceramic may be a low temperature polymer derived ceramic that forms a ceramic during, e.g., extrusion or some other relatively low temperature pre-sintering step. In this context, polymer derived ceramics may, for example, include any material with polymer-like properties that can cross-link for desired rheological properties and convert at elevated temperatures into a ceramic. This may include silicon nitride and silicon carbide forming materials, as well as other materials that convert to oxide-based ceramics such as alumina, zirconia, silicon oxycarbide, and the like. The viscosity of the polymeric material can be adjusted by proper selection of the ceramic precursor material's chemical structure and molecular weight, with typical molecular weights ranging from several hundred Daltons to one hundred kiloDaltons. Thus, depending on the particular materials, this interface layer former may usefully be deposited in an extrusion-based fabrication process such as fused deposition modeling, or may be sprayed as a liquid, e.g., to form an interface layer in a binder jetted structure.

In yet another aspect, a variety of surface treatments may be used to prevent or discourage adhesion at the interface between two surfaces such as an object and a support. For example, one or more of these surfaces may be passivated with an oxide, or another chemical that creates a passivated layer that will not react with or bond to the other surfaces at the interface. In another aspect, the surface treatment may create a brittle surface.

Such surface treatments may be applied as a coating or plating of a material that passivates, or encourages passivation of, the corresponding layer. For example, the surface treatment may turn a metal powder in a build material or support material into a metal oxide in situ.

More generally, any thermal or chemical process that can be applied to a surface to passivate the surface, or to embrittle an area, may be used to provide an interface layer that facilitates separation of adjacent layers after thermal processing.

Now that exemplary embodiments of the present disclosure have been shown and described in detail, various modifications and improvements thereon will become readily apparent to those of ordinary skill in the art, all of which are intended to be covered by the following claims.

What is claimed is:

1. An interface layer formed between an object being printed by a 3D printer and an underlying support structure, said interface layer comprising a glass-based material.

2. The interface layer of claim 1 wherein said glass-based material comprises a silica glass.

3. The interface layer of claim 1 wherein the glass-based material is selected to have a glass transition temperature below a sintering temperature used to process the object after it is printed.

4. The interface layer of claim 1, wherein the glass-based material is selected from the group consisting of soda-lime glass, borosilicate glass, lead-alkali glass and fiber glass or combinations thereof.

5. The interface layer of claim 4, further including a refractory metal.

6. An interface layer formed between an object being printed by a 3D printer and an underlying support structure, said interface layer comprising a cermet.

7. The interface layer of claim 7, wherein the cermet is formed from a combination of steel and ceramic when said object being printed is steel.

8. The interface layer of claim 8, wherein the ceramic is aluminum oxide.

9. The interface layer of claim 6, wherein the cermet is selected from the group of titanium and zirconium oxide or combinations thereof, when the object being printed is titanium.

10. The interface layer of claim 7, wherein the cermet is selected from the group of titanium aluminide and zirconium dioxide when the object being printed is titanium.

11. An interface layer formed between an object being printed by a 3D printer and an underlying support structure, said interface layer comprising a ceramic macrostructure.

12. The interface layer of claim 11, wherein said interface layer comprises ceramic paper.

13. An interface layer formed between an object being printed by a 3D printer and an underlying support structure, said interface layer being formed from a polymer derived ceramic.

14. A method of 3D printing an object having a dissolvable support using binder jetting, wherein the method comprises the steps of:
forming layers of said object and support by selectively depositing a binder onto a bed of powder,
introducing an agent during said 3D printing to locally modify corrosion characteristics of one or more regions of said object or support or of an interface layer therebetween to facilitate dissolution of the support from the object after printing and any subsequent processing is completed.

15. The method of Clam 14, wherein the agent is introduced through an inkjet print head.

16. The method of claim 14, wherein the agent is introduced by depositing a carbon black-laden suspension.

17. The method of claim 14, wherein the agent is introduced as a polymer that may be pyrolyzed to leave a carbon-containing deposit.

18. The method of claim 14 wherein the locally modified one or more regions have a reduced corrosion characteristic.

19. The method of claim 14, wherein the locally modified one or more regions have an increased corrosion characteristic.

20. A method of 3D printing an object having a dissolvable support by using an extrusion type 3D printer, wherein the method comprises the steps of:
extruding and depositing materials to form the object and the support,
introducing an agent during said 3D printing to locally modify corrosion characteristics of one or more regions of said object or said support or an interface layer therebetween, to facilitate dissolution of the support from the object after printing and any subsequent processing is completed.

21. The method of claim 20, wherein the agent is introduced by depositing a carbon black-laden suspension.

22. The method of claim 20, wherein the agent is introduced by depositing a polymer that may be pyrolyzed to leave a carbon-containing deposit.

23. The method of claim 20, wherein the agent locally modifies the one or more regions to have either a reduced corrosion characteristic or increased corrosion characteristic relative to the rest of the object or support.
